(19) United States
(12) Patent Application Publication
(10) Pub. No.: US 2026/0340941 A1
(43) Pub. Date: Oct. 29, 2026

(54) DETERMINING BOUNDING VOLUMES BASED ON SPHERE CARVING

(71) Applicant: Adobe Inc., San Jose, CA (US)

(72) Inventors: Axel Florent Jacques Paris, Paris (FR); Thibaud Pierre Emilien Lambert, Paris (FR); Theo Thonat, Paris (FR); Hugo Amedee Schott, Villeurbanne (FR)

(73) Assignee: Adobe Inc., San Jose, CA (US)

(21) Appl. No.: 19/193,664

(22) Filed: Apr. 29, 2025

(51) Int. Cl. G06T 17/20

(52) U.S. Cl. CPC G06T 17/20

(57) ABSTRACT

In implementation of techniques for determining bounding volumes based on sphere carving, a computing device implements a sphere carving system to receive data indicating distances from points in space a surface of a three-dimensional object. The sphere carving system identifies a virtual representation that encloses the three-dimensional object. By iteratively removing portions between a surface of the virtual representation and the surface of the three-dimensional object, the sphere carving system generates a virtual shell based on a geometry of the three-dimensional object. The sphere carving system then outputs data related to the virtual shell.

### BACKGROUND

In computer graphics, signed distance fields are used to represent shapes and virtual three-dimensional objects in a compact form. Signed distance fields store values indicating a shortest distance from any point in space to the surface of a virtual object, including a sign indicating whether the point is located inside or outside the virtual object. Applications of signed distance fields include real-time rendering, collision detection, procedural modeling, font rendering, and physics simulations. However, performing geometric operations on signed distance fields results in computational inefficiencies and increased power consumption in real world scenarios.

### SUMMARY

Techniques and systems for determining bounding volumes based on sphere carving are described. In an example, a sphere carving system receives data involving a signed distance field function. The signed distance field function, for instance, is queried to determine distances from points in space to a surface of a three-dimensional object.

The sphere carving system identifies a virtual representation that encloses the three-dimensional object. In this example, the virtual representation has a spherical geometry. Some examples further comprise selecting a size of the virtual representation that avoids intersecting the surface of the three-dimensional object.

By iteratively removing portions between a surface of the virtual representation and the surface of the three-dimensional object, the sphere carving system generates a virtual shell based on a geometry of the three-dimensional object. For instance, the virtual shell is a bounding volume. In this example, the portions iteratively removed between the surface of the virtual representation and the surface of the three-dimensional object also have a spherical geometry. For instance, iteratively removing the portions between the surface of the virtual representation and the surface of the three-dimensional object involves determining distances of surface points of the portions to the surface of the three-dimensional object.

The sphere carving system then outputs data related to the virtual shell. In this example, the data related to the virtual shell indicates intersection points from the portions, and some examples further comprise outputting a mesh generated based on the intersection points. For instance, the data related to the virtual shell indicates a convex hull formed based on intersection points from the portions.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for determining bounding volumes based on sphere carving as described herein.

FIG. 2 depicts a system in an example implementation showing operation of a sphere carving module for determining bounding volumes based on sphere carving.

FIG. 3 depicts an example of identifying an initial sphere based on a signed distance field.

FIG. 4 depicts an example of carving spherical cutouts from the initial sphere.

FIG. 5 depicts an example of determining a convex hull based on the spherical cutouts.

FIG. 6 depicts an example of generating a bounding volume.

FIG. 7 depicts an example of different bounding volumes for a signed distance field.

FIG. 8 depicts a procedure in an example implementation of determining bounding volumes based on sphere carving.

FIG. 9 depicts a procedure in an additional example implementation of determining bounding volumes based on sphere carving.

FIG. 10 illustrates an example system including various components of an example device that can be implemented as any type of computing device as described and/or utilized with reference to FIGS. 1-9 to implement embodiments of the techniques described herein.

### DETAILED DESCRIPTION

### Overview

A signed distance field is a scalar function that represents a three-dimensional object by storing, at a given point in space, a shortest distance to a surface of the three-dimensional object. Positive values, for instance, indicate points located outside the object, negative values indicate points located inside the object, and values of zero indicate points on the surface of the object. However, signed distance fields represent geometry implicitly as a continuous function, rather than as explicit elements including vertices and faces. This makes performing computational operations on the signed distance fields complex because there is no direct correspondence to discrete geometry. For instance, performing computations involving rendering or physics-based simulations on signed distance functions are difficult and computationally intensive.

When performing the computational operations, a bounding volume serves as a useful proxy for the signed distance field. This is because bounding volumes have simpler geometries than signed distance fields and are defined by parameters including position, size, and orientation, making bounding volumes less complex to manipulate and perform computational operations than signed distance fields.

Conventional bounding volume generation techniques involve extracting bounds of the object represented by the signed distance field by densely sampling points in space. However, these conventional bounding volume generation techniques are time consuming and resource intensive.

Techniques and systems are described for determining bounding volumes based on sphere carving that overcome these limitations. For example, an initial sphere is generated that encloses the three-dimensional object represented by the signed distance function. Smaller spherical portions are then iteratively carved from the initial sphere, up to a surface of the three-dimensional object. A bounding volume is then determined based on intersection points of the spherical portions carved from the initial sphere, which estimates a geometry of the three-dimensional object.

A sphere carving system begins in this example by receiving an input including a signed distance field that represents a three-dimensional object. To generate a bounding volume based on the signed distance field, the sphere carving system first identifies an initial sphere configured to enclose the three-dimensional object. The sphere carving system, for instance, determines a size for the initial sphere that fully encloses the three-dimensional object, without intersecting or contacting a surface of the three-dimensional object. The initial sphere is represented as a virtual, spherical mass in space, which is configured for having portions extracted or “carved” from the initial sphere.

The sphere carving system then determines spherical cutouts to carve the initial sphere. The sphere carving system, for instance, iteratively carves the spherical cutouts from the initial sphere. To do so, the sphere carving system removes portions of the initial sphere from a region of the initial sphere between a surface of the initial sphere and the surface of the three-dimensional object represented by the signed distance field, which is positioned inside the initial sphere in this example. Accordingly, the sphere carving system removes spherical cutouts that are progressively smaller as the sphere carving system fine-tunes a geometry of the initial sphere based on the signed distance field. The spherical cutouts, for instance, are carved up to the surface of the three-dimensional object, while avoiding intersections with the surface of the three-dimensional object. This results in a carved remainder of the initial sphere that has a geometry resembling the three-dimensional object.

The sphere carving system then identifies intersection points based on intersections of the spherical cutouts, which form a sphere cloud surrounding the signed distance field. Together, the intersection points form a point cloud surrounding the signed distance field. By connecting the intersection points of the point cloud, the sphere carving system forms a convex hull, which is a type of a bounding volume that encloses the three-dimensional object represented by the signed distance field.

The sphere carving system then outputs data related to the bounding volume. In an example, the data related to the bounding volume is leveraged to edit or apply further operations to the three-dimensional object represented by the signed distance field. For example, the bounding volume has a discrete geometry that is more simple to edit than the signed distance field. Furthermore, the bounding volume is a proxy for the signed distance field and is useful for rendering, generating meshes and generating physics-based simulations related to the three-dimensional object.

Determining bounding volumes based on sphere carving in this manner overcomes the disadvantages of conventional bounding volume generation techniques that are limited to extracting bounds of the object represented by the signed distance field by densely sampling points in space. For example, carving an initial sphere enclosing a three-dimensional object represented by a signed distance field reveals a geometry of the three-dimensional object while avoiding sampling points. For these reasons, determining bounding volumes based on sphere carving is faster and less resource intensive than the conventional bounding volume generation techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

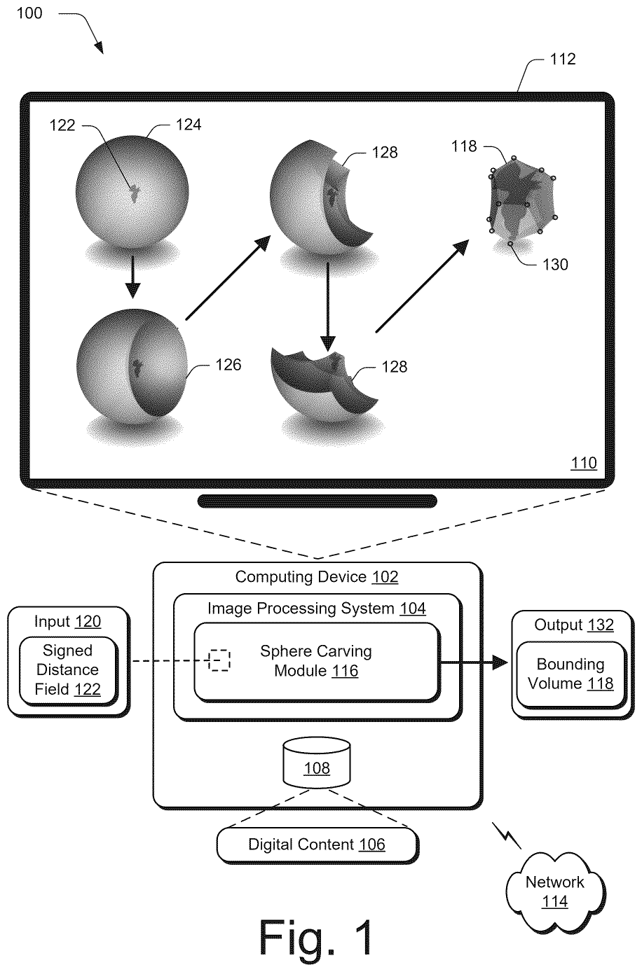

FIG. 1 is an illustration of a digital medium environment 100 in an example implementation that is operable to employ techniques and systems for determining bounding volumes based on sphere carving described herein. The illustrated digital medium environment 100 includes a computing device 102, which is configurable in a variety of ways.

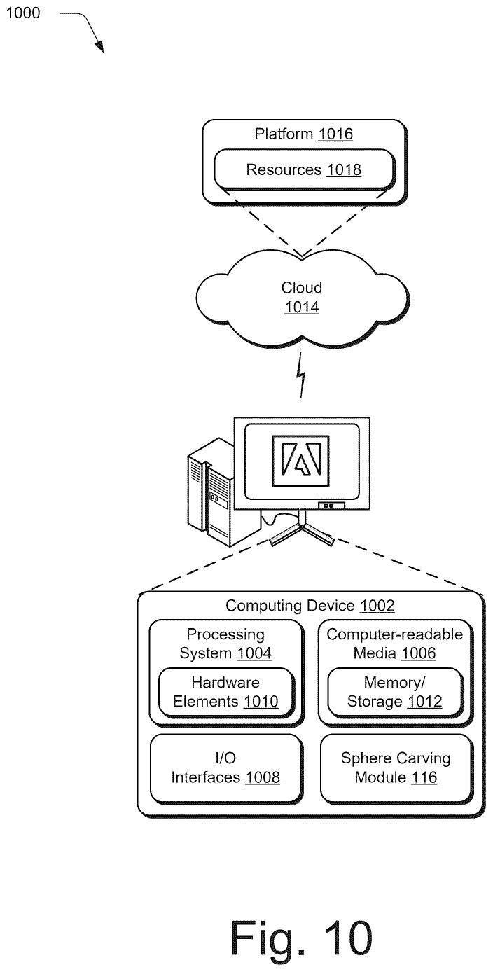

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 10.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes a sphere carving module 116 which is illustrated as incorporated by the image processing system 104 to process the digital content 106. In some examples, the sphere carving module 116 is separate from the image processing system 104 such as in an example in which the sphere carving module 116 is available via the network 114.

The sphere carving module 116 is configured to generate a bounding volume 118 based on an input 120 including a signed distance field 122. The signed distance field 122 in this example is a mathematical representation of a three-dimensional object in space, including points indicating a shortest distance to a closest point on the surface of the three dimensional object. However, the signed distance field 122 is not conducive to performing computational operations including rendering with ray tracing or physics-based operations and therefore the bounding volume 118 based on the signed distance field 122 is useful as a proxy to perform these operations on the three-dimensional object. In contrast to the signed distance field 122, the bounding volume 118 is a shell having a geometry based on the three-dimensional object and is more efficient to query than the signed distance field 122.

To begin, the sphere carving module 116 identifies an initial sphere 124 that encloses the signed distance field 122. For instance, the sphere carving module 116 determines a size for the initial sphere 124 that avoids intersecting surfaces of the three-dimensional object represented by the signed distance field 122. In some examples, the sphere carving module 116 determines the size based on information related to locations of the surface points of the signed distance field 122.

The sphere carving module 116 then iteratively carves spherical cutouts from the initial sphere 124, carving progressively closer to the surface of the three-dimensional object represented by the signed distance field 122. As shown in this example, the sphere carving module 116 carves an initial spherical cutout 126, followed by successive spherical cutouts 128. The successive spherical cutouts 128, for instance, further refine the initial sphere 124 into a representation having a geometry resembling the three-dimensional object represented by the signed distance field 122, without intersecting the surface of the three-dimensional object.

The carving results in intersection points 130, forming a point cloud. The intersection points 130, for instance, indicate intersections of the spherical portions nearest to the signed distance field 122. When connected, for instance, the intersection points 130 of the point cloud form the geometry resembling the three-dimensional object represented by the signed distance field 122. Based on the intersection points 130, the sphere carving module 116 generates the bounding volume 118, which is a convex hull having the geometry resembling the three-dimensional object represented by the signed distance field 122 in this example. In some examples, the bounding volume 118 indicates multiple separated component three-dimensional objects that form the three-dimensional object represented by the signed distance field 122.

The sphere carving module 116 then outputs data related to the bounding volume 118. For instance, the bounding volume 118 is usable to render, edit, or perform other geometric operations on the object represented by the signed distance field 122. In some examples, the sphere carving module 116 generates an output 132 including a mesh based on the bounding volume 118 for rendering in the user interface 110.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Determining Bounding Volumes Based on Sphere Carving

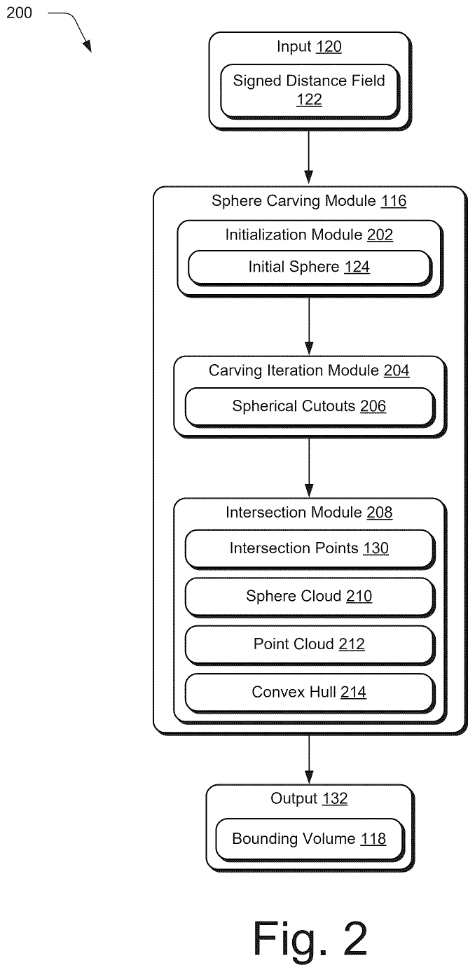

FIG. 2 depicts a system 200 in an example implementation showing operation of the sphere carving module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-10.

To begin in this example, a sphere carving module 116 receives an input 120 including a signed distance field 122. The signed distance field 122 is a virtual representation in three-dimensional space that is queried to generate data including distance values indicating a shortest distance to a surface of a three-dimensional object. In some examples, the signed distance field 122 is expressed procedurally as a function or as a discrete set of point samples.

The sphere carving module 116 includes an initialization module 202 that is configured to identify an initial sphere 124 based on the signed distance field 122. The initialization module 202, for instance, determines a size for the initial sphere 124 relative to the three-dimensional object represented by the signed distance field 122 that fully encloses the three-dimensional object, without intersecting or contacting the three-dimensional object. The initial sphere 124 is represented as a virtual, solid spherical mass in space, which is capable of having portions extracted or “carved” from the initial sphere 124.

The sphere carving module 116 also includes a carving iteration module 204 that is configured to determine spherical cutouts 206 to carve the initial sphere 124. The carving iteration module 204, for instance, iteratively removes or “carves” the spherical cutouts 206 from the initial sphere 124. The carving iteration module 204 removes portions of the initial sphere 124 based on the spherical cutouts 206 from a region of the initial sphere 124 between a surface of the initial sphere 124 and the three-dimensional object represented by the signed distance field 122, which is positioned inside the initial sphere 124 for this determination. Accordingly, the carving iteration module 204 removes spherical cutouts 206 what are progressively smaller as the carving iteration module 204 fine-tunes a geometry of the initial sphere 124 based on the signed distance field 122 via the carving. The spherical cutouts 206, for instance, do not intersect the surface of the three-dimensional object represented by the signed distance field 122 in this example, and instead are carved progressively closer to the surface of the three-dimensional object.

The sphere carving module 116 also includes an intersection module 208 that is configured to generate a bounding volume 118. To begin, the intersection module 208 identifies intersection points 130 based on intersections of the spherical cutouts 206, which form a sphere cloud 210 surrounding the signed distance field 122. Together, the intersection points 130 form a point cloud 212 surrounding the signed distance field 122. By connecting the intersection points 130 of the point cloud 212, the sphere carving module 116 forms a convex hull 214, which is a type of a bounding volume 118 that closely encloses the three-dimensional object represented by the signed distance field 122.

The sphere carving module 116 then generates an output 132 including data related to the bounding volume 118. The output 132, for instance, involves data indicating the bounding volume 118, which is the convex hull 214 in this example. The data indicating the bounding volume 118 is then leveraged to perform operations involving rendering, generating meshes, or generating physics-based simulations to the three-dimensional object represented by the signed distance field 122 in this example.

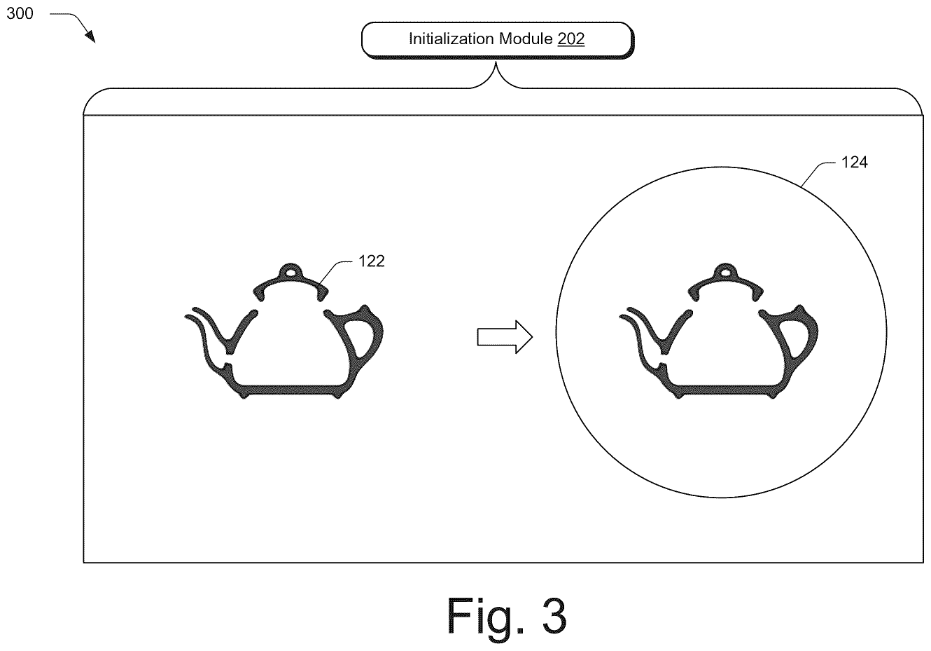

FIGS. 3-7 depict stages of determining bounding volumes based on sphere carving. In some examples, the stages depicted in these figures are performed in a different order than described below.

FIG. 3 depicts an example 300 of identifying an initial sphere based on a signed distance field. As illustrated, an initialization module 202 of the sphere carving module 116 receives a signed distance field 122 representing a three-dimensional object, which is depicted as a teapot in this example. Although the teapot is three-dimensional, this example depicts a two-dimensional cross-section of the teapot for illustrative purposes.

Different types of signed distance fields are contemplated in this example, including signed distance fields that are discrete (i.e., involving interpolation over a set of discrete distance samples, typically in a grid), analytic (i.e., involving closed-form mathematical formula), or defined from another process (i.e., for instance neural signed distance fields). The three types of signed distance fields define a function ƒ that computes the signed distance to a surface of the three-dimensional object. For three-dimensional objects with complex geometries, the signed distance field 122 becomes more complex, and the mathematical expression of the signed distance field 122 becomes computationally expensive to process, preventing creation and editing of three-dimensional objects over large scenes in an interactive manner. A bounding volume 118 is therefore generated based on the signed distance field 122 because the bounding volume 118 is more conducive to editing than the signed distance field 122.

Regarding the teapot in this example, a shortest distance to the surface of the teapot mesh is computed and stored at a given voxel, with a sign indicating whether a point lies inside (negative) or outside (positive) the surface of the teapot. The signed distance field 122 therefore involves a volumetric dataset including a dense field of distance values that represents the three-dimensional shape of the teapot.

In this example, the function ƒ of the signed distance field 122 is a conservative or exact distance function. This allows for performance of faster queries on the signed distance field 122 function in a large portion of space, typically useful in the context of sphere tracing or polygonization.

The signed distance field 122 is represented as ƒ: [symbol] ³ [symbol] [symbol] , and the object [symbol] described by its 0 level set. As explained above, the function ƒ is exact or conservative. An exact signed distance field provides the exact distance between a point p and the object [symbol] (∇p∈ [symbol] ³, ƒ(p)=d (p, [symbol] )). However, this typically provides a lower distance bound (i.e ∇p∈ [symbol] ³, ƒ(p)<d (p, [symbol] )), which is considered conservative. In these cases, a fundamental property is verified. At the points outside of the three-dimensional object, an initial sphere 124 is determined, which surrounds the three-dimensional object and is generated by evaluating ƒ for its radius. For example, let p∈ [symbol] ³ such that ƒ(p)>0, and the initial sphere 124 s(p, ƒ(p)) is “empty” of [symbol] :∇q∈ [symbol] ³ s.t d(q, p)<ƒ(p), ƒ(q)>0. This provides that the initial sphere 124 s is empty of a surface of the three-dimensional object.

The following notation is applicable to the discussion of determining bounding volumes based on sphere carving. The initial sphere 124 s(c,r) of radius r∈ [symbol] is centered on c∈ [symbol] ³. A set Ωₛ includes spheres in [symbol] ³. A sphere cloud S is a set of N spheres.

An interior space C̅(S) of S includes union of spheres, points that are strictly inside at least one sphere of S:

C̅(S)={p∈ [symbol] ³|∃s(c,r)∈S s.t∥p−c∥<r}

An exterior space C(S) of S is complementary of C̅(S), including points that are outside every sphere of S (i.e., a “carved” space):

$$\begin{matrix}C ( S ) = \{ p ∈ {ℝ}^{3} \vert p ∉ \overline{C} ( S ) \} \\ = \{ p ∈ {ℝ}^{3} \vert ∀ s ( c , r ) ∈ S , ‖ p - c ‖ \geq r \}\end{matrix}$$

A point cloud P is a set of M points in [symbol] ³. A convex hull H(P) relates to the point cloud P.

Regarding intersection points, intersection I(S) of S is an intersection of the spheres of S.

$$I ( S ) = {⋂}_{s ∈ S} s = \{ p ∈ {ℝ}^{3} \vert ∀ s ∈ S , p ∈ s \} \\ where \\ p ∈ s ( c , r ) ⇔ ‖ p - c ‖ = r$$

A 3-Intersection I₃(S) of S includes points that belong to the intersection of a 3-spheres subset of S.

I₃(S)={p∈ [symbol] ³|∃S₃⊂S,#S=3s.t p∈I(S₃)}

A valid 3-intersection set I₃(S) of S includes points that belong to the 3-intersection of S, and to its exterior space C(S).

Ĩ₃(S)=I₃(S)∩C(S)

In this example, the initialization module 202 identifies a size of the initial sphere 124 that encompasses an entirety of the three-dimensional object represented by the signed distance field 122. For instance, the signed distance field 122 function ƒ is defined within space, and the size of the initial sphere 124 is not limited in this example. In this example, the initialization module 202 determines a size so (c₀, r₀) for the initial sphere 124. The initial sphere 124 is represented as a virtual solid mass, suitable for carving and to create the first sphere cloud S₀, and for discarding portions of spherical cutouts 206 that fall in the empty space outside of the initial sphere 124.

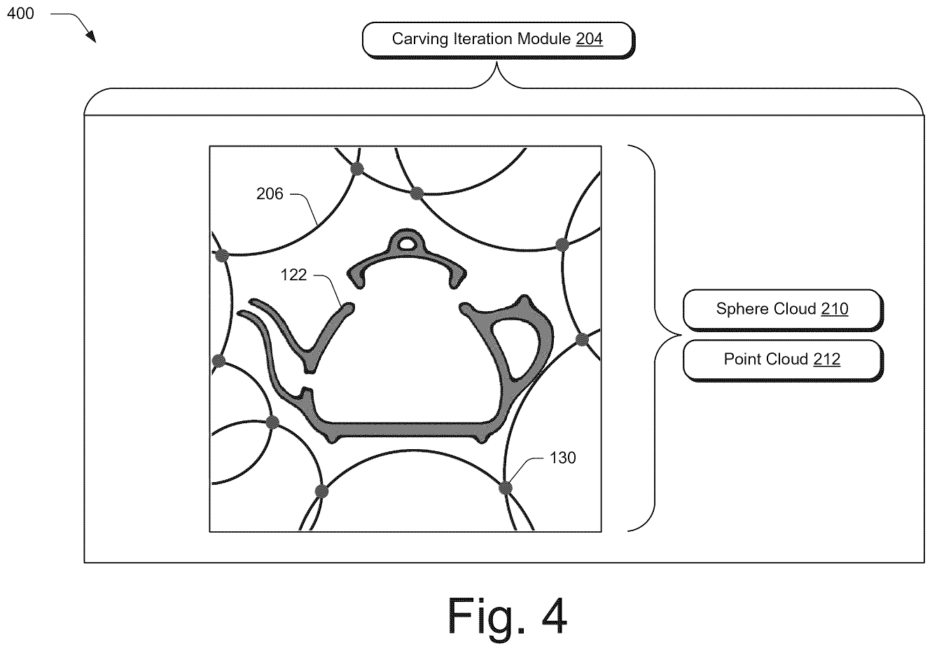

FIG. 4 depicts an example 400 of carving spherical cutouts from the initial sphere. FIG. 4 is a continuation of the example described in FIG. 3. After the initialization module 202 identifies the initial sphere 124, a carving iteration module 204 carves spherical cutouts 206 from the initial sphere 124 around the three-dimensional object represented by the signed distance field 122.

As illustrated, the carving iteration module 204 iteratively removes or “carves” the spherical cutouts 206 from the initial sphere 124. The carving iteration module 204 removes portions of the initial sphere 124 based on the spherical cutouts 206 from a region of the initial sphere 124 between a surface of the initial sphere 124 and the three-dimensional object represented by the signed distance field 122, which is positioned inside the initial sphere 124. Accordingly, the carving iteration module 204 removes spherical cutouts 206 what are progressively smaller as the carving iteration module 204 fine-tunes a geometry of the initial sphere 124 based on the signed distance field 122 via the carving. The spherical cutouts 206, do not intersect the surface of the three-dimensional object represented by the signed distance field 122 in this example, and instead are carved progressively closer to the surface of the three-dimensional object.

For instance, the initial sphere 124 is identified as an unknown space including the signed distance field 122, however a location and a size of the signed distance field 122 relative to the initial sphere 124 are unknown prior to carving. The goal of the sphere carving is to reduce the unknown space by carving closer to the three-dimensional object represented by the signed distance field 122.

A sphere cloud S and a point cloud P=Ĩ₃(S) result from a given step of the sphere carving. For instance, the sphere cloud S is outside the object [symbol] defined by ƒ:

∇p∈C̅(S)ƒ(p)>0

The convex hull of P is a bounding to ƒ:

∇p∉H(P)ƒ(p)>0

The carving iteration module 204 selects initial points for the spherical cutouts 206 far from the three-dimensional object, resulting in the spherical cutouts 206 being “empty” (i.e., not interesting the three-dimensional object). The intersection points 130 lie on the surface of an empty sphere and are therefore outside the three-dimensional object represented by the signed distance field 122. Consequently, spherical cutouts 206 are built on the intersections and are empty as well, resulting in the sphere cloud 210 being outside the three-dimensional object.

After reducing the unknown space of the initial sphere 124 sphere so, the carving iteration module 204 begins carving inside a remainder of the initial sphere 124 to produce the sphere cloud 210. To uniformly sample the surface of so, the carving iteration module 204 uses vertices of an icosphere, which is a type of three-dimensional sphere approximation created by subdividing the faces of an icosahedron, a polyhedron with 20 equilateral triangle faces. Furthermore, to obtain the point cloud 212 P₀, with a bounding convex hull, the surface of so is covered by the spheres of S₀.

Considering iteration i, with the sphere cloud Sᵢ and the associated point cloud Pᵢ, the carving iteration module 204 advances to iteration i+1, by incorporating a new set of spheres \tilde{S}ᵢ to Sᵢ. The new set of spheres are positioned at intersection point in Pᵢ, with a radius given by the signed distance field function ƒ:

Sᵢ₊₁=Sᵢ∪Šᵢ

Šᵢ={s(p,ƒ(p))|p∈Pᵢ}

Then, the point cloud 212 is updated to contain the valid 3-intersections of the new sphere cloud:

Pᵢ₊₁=Ĩ₃(Sᵢ₊₁)

and a convex hull based on the point cloud 212 progresses closer to the geometry of the three-dimensional object at each iteration. The result of the sphere carving by the carving iteration module 204 includes the sphere cloud 210 Sₙ and the point cloud 212 Pₙ, which are finalized. The relevant information describing the three-dimensional object is contained in Pₙ, and is then further processed to determine the bounding volume 118 in some examples.

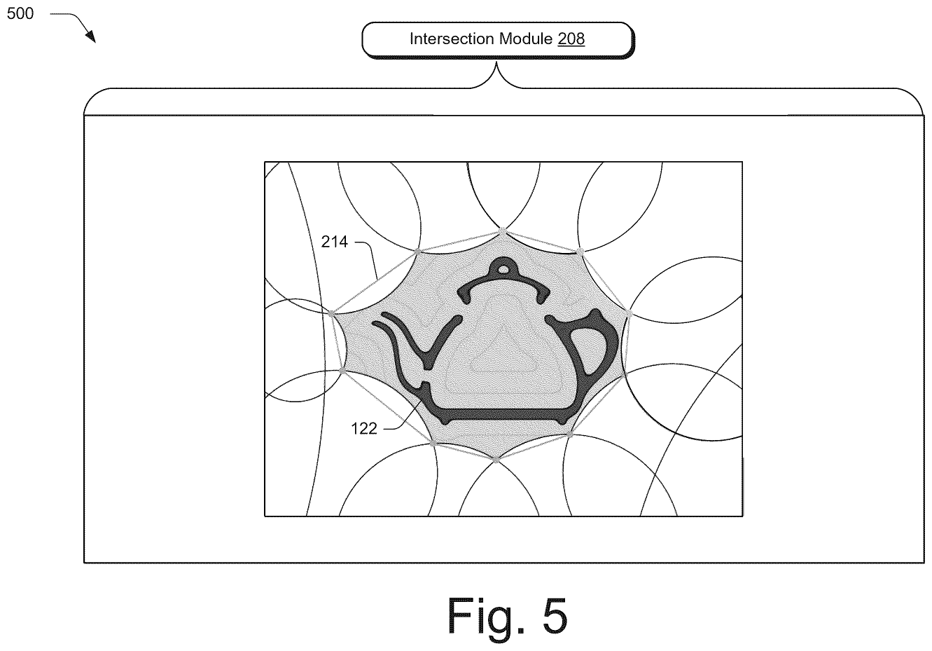

FIG. 5 depicts an example 500 of determining a convex hull based on the spherical cutouts. FIG. 5 is a continuation of the example described in FIG. 4. After the carving iteration module 204 carves the initial sphere 124 using spherical cutouts 206 to obtain a sphere cloud 210 and a point cloud 212, an intersection module 208 of the sphere carving module 116 determines a convex hull 214.

In this example, the intersection module 208 connects the intersection points 130 of the point cloud 212, forming a convex hull 214. The intersection points 130 correspond to three-sphere intersections of the spherical cutouts 206 along an innermost surface of the sphere cloud 210. The convex hull 214 is a type of a bounding volume 118 that encloses the three-dimensional object represented by the signed distance field 122.

This example involves implicit convex bounding volumes, in which the convex hull 214 of Pₙ is bounding the three-dimensional object represented by the signed distance field 122. The convex hull H(Pₙ) is computed using a three-dimensional quickhull algorithm, obtaining a set of triangles that the intersection module 208 interprets as a set [symbol] (Pₙ) of oriented planes h. For instance, the quickhull algorithm identifies outermost points (e.g., with the smallest and largest x-values) to form an initial edge and then finds the point farthest from this edge to form a triangle and eliminates points inside the triangle. The remaining points are divided into subsets on either side of the triangle, and the process repeats recursively to identify a farthest point, forming new edges, and discarding interior points until the boundary points of the convex hull 214 are identified.

Building the distance function [symbol] of a convex shape involves the intersection of every halfspace hᵢ:

$${h}_{i} : {c}_{i} point , {n}_{i} normal \\ d ( {h}_{i} , p ) = ( p - {c}_{i} ) \cdot {n}_{i} \\ {f}_{ℋ} ( p ) = {max}_{i} d ( {h}_{i} , p )$$

Because some planes of the convex hull 214 are not relevant, the intersection module 208 simplifies the convex hull 214, while maintaining a conservative (bounding to [symbol] ) bound and convex bound. Here, the operation of removing a half-space hₖ from the set [symbol] (Pₙ) maintains a conservative and convex bound. Therefore, the intersection module 208 selects relevant planes from the set [symbol] (Pₙ) that simplify the hull while satisfying the bounding and convexity constraints.

To make this selection, the intersection module 208 leverages a K-means algorithm by applying it to the set of half-space [symbol] (Pₙ), searching for K clusters and considering their orientations (e.g., the normal vector of the plane). Once converged, the intersection module 208 projects the obtained clusters on the existing half-spaces, obtaining a reduced set [symbol] _{K}(Pₙ), still bounding to the three-dimensional object, with a volume close to the full hull, and with a simplified function [symbol] .

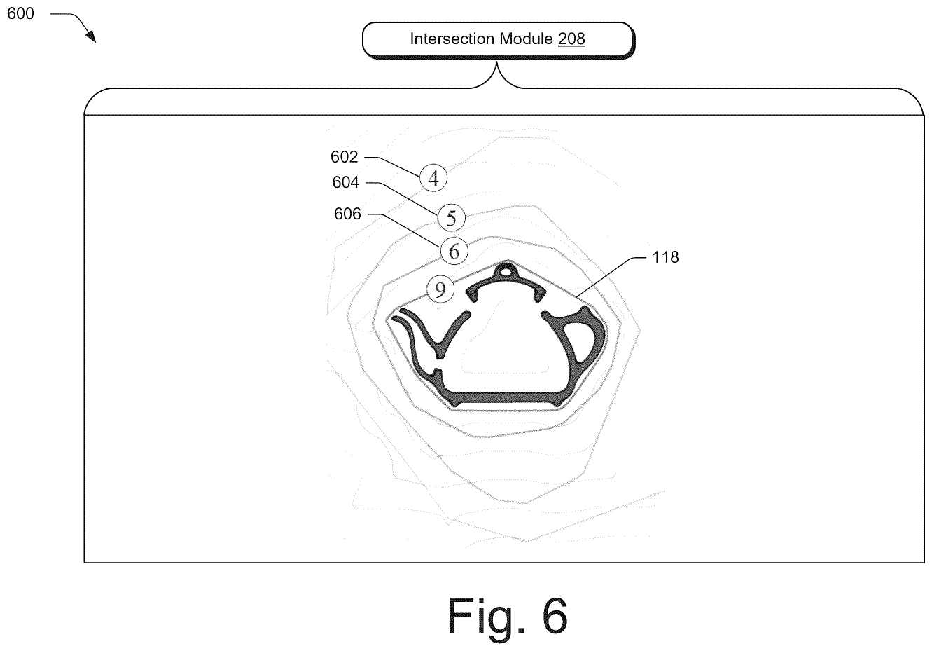

FIG. 6 depicts an example 600 of generating a bounding volume. FIG. 6 is a continuation of the example described in FIG. 5. This example depicts different levels of bounding volumes generated based on different amount of sphere carving around the object represented by the signed distance field 122.

As shown in this example, a first bounding volume 602 is generated based on four iterations of sphere carving, a second bounding volume 604 is generated based on five iterations of sphere carving, a third bounding volume 606 is generated based on six iterations of sphere carving, and the bounding volume 118 is generated, which is the final bounding volume generated based on nine iterations of sphere carving. When connected, for instance, the intersection points 130 of the point cloud form the geometry resembling the three-dimensional object represented by the signed distance field 122. Based on the intersection points 130, the sphere carving module 116 generates the bounding volume 118, which is a convex hull represented by the signed distance field 122 in this example.

The sphere carving module 116 then outputs data related to the bounding volume 118, which is applicable for a variety of geometric operations related to the object represented by the signed distance field 122. Overall, the bounding volume 118 acts as an efficient spatial filter, streamlining editing tasks and other geometric operations on the three-dimensional object represented by the signed distance field 122.

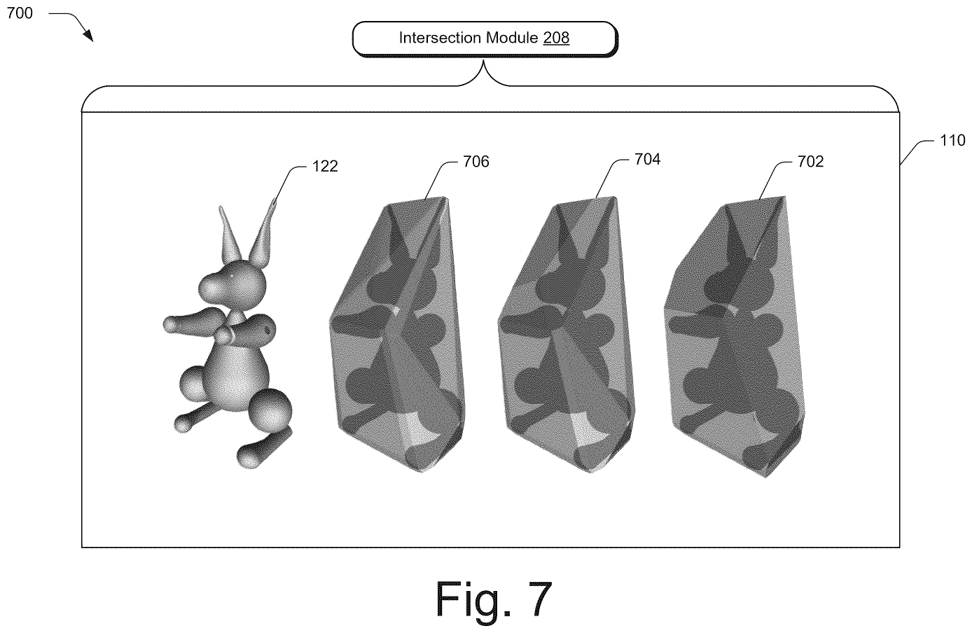

FIG. 7 depicts an example 700 of different bounding volumes for a signed distance field. This example involves a first bounding volume 702, a second bounding volume 704, and a third bounding volume 706 generated based on a signed distance field 122. For instance, the first bounding volume 702, the second bounding volume 704, and the third bounding volume 706 are convex hulls in this example.

As shown in this example, the first bounding volume 702 is formed from 18 planes, the second bounding volume 704 is formed from 35 planes, and the third bounding volume 706 is formed from 154 planes. Here, the number of planes correlates to a granularity of the sphere cloud 210 used for generating the bounding volumes. For instance, carving involving a larger number of spherical cutouts results in denser sphere clouds and point clouds. In turn, this also affects the number of planes and overall resolution of the bounding volumes.

This example illustrates how the representation of a given bounding volume changes based on a number of planes. In some examples, bounding volumes with lower resolutions (e.g., the first bounding volume 702 or the second bounding volume 704) are lighter to process than bounding volumes with higher resolutions (e.g., the third bounding volume 706).

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-7.

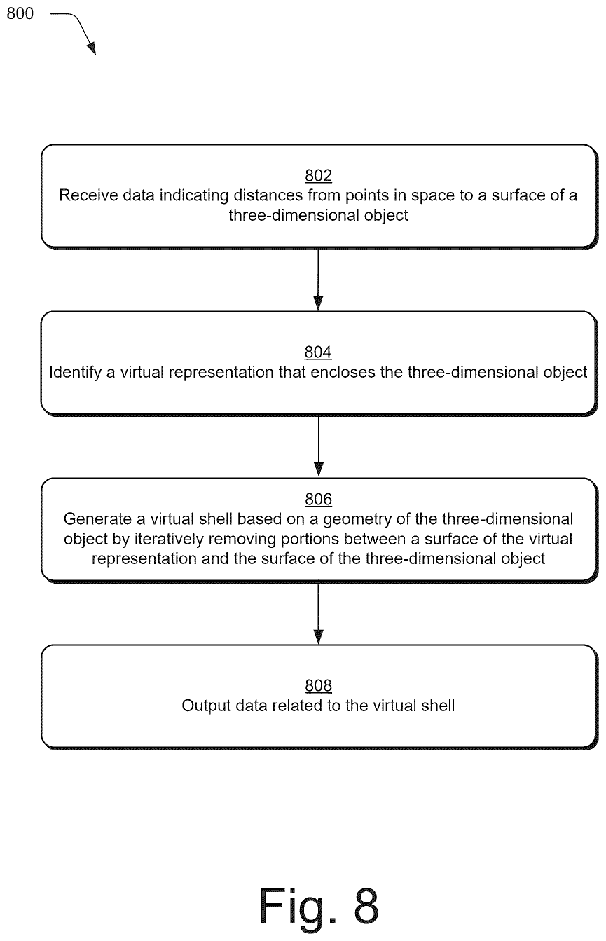

FIG. 8 depicts a procedure 800 in an example implementation of determining bounding volumes based on sphere carving. At block 802 data indicating distances from points in space to a surface of a three-dimensional object is received. For example, the data involves a signed distance field 122 function.

At block 804, a virtual representation that encloses the three-dimensional object is identified. In some examples, a size of the virtual representation is selected that avoids intersecting the surface of the three-dimensional object.

At block 806, a virtual shell is generated based on a geometry of the three-dimensional object by iteratively removing portions between a surface of the virtual representation and the surface of the three-dimensional object. In some examples, the virtual representation has a spherical geometry, and the portions between the surface of the virtual representation and the surface of the three-dimensional object have a spherical geometry. In an example, the virtual shell is a bounding volume 118. Additionally or alternatively, some examples involve determining distances of surface points of the portions to the surface of the three-dimensional object.

At block 808, data related to the virtual shell is output. For instance, the data related to the virtual shell indicates intersection points 130 from the portions, and some examples further comprise outputting a mesh generated based on the intersection points 130. In some examples, data related to the virtual shell indicates multiple component three-dimensional objects that form the three-dimensional object. Additionally, in some examples, the data related to the virtual shell indicates a convex hull 214 formed based on intersection points 130 from the portions. Further, some examples involve editing the three-dimensional object based on the data related to the virtual shell.

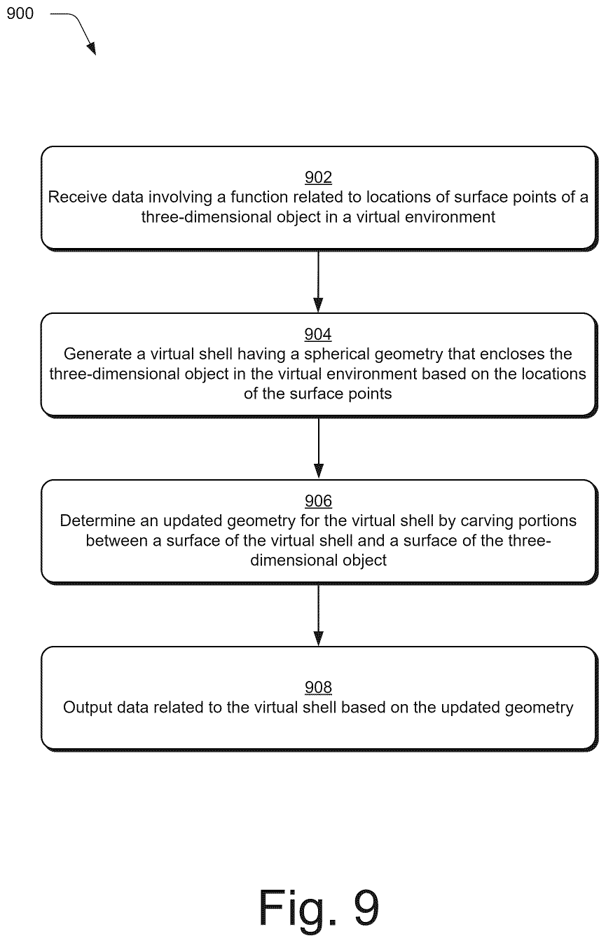

FIG. 9 depicts a procedure 900 in an additional example implementation of determining bounding volumes based on sphere carving. At block 802, data involving a function related to locations of surface points of a three-dimensional object in a virtual environment is received. In this example, the function is a signed distance field 122 function.

At block 904, a virtual shell having a spherical geometry that encloses the three-dimensional object in the virtual environment based on the locations of the surface points is generated. For example, the virtual shell has an initial size of the virtual representation that avoids intersecting the surface of the three-dimensional object.

At block 906, an updated geometry for the virtual shell is determined by carving portions between a surface of the virtual shell and a surface of the three-dimensional object. In some examples, the virtual shell has an initial geometry that is spherical, and the portions between the surface of the virtual shell and the surface of the three-dimensional object have a spherical geometry. Some examples further involve determining distances of surface points of the portions to the surface of the three-dimensional object.

At block 908, data related to the virtual shell is output based on the updated geometry. In an example, the data related to the virtual shell involves a bounding volume 118. Additionally or alternatively, data related to the virtual shell indicates multiple component three-dimensional objects that form the three-dimensional object. For instance, the data related to the virtual shell indicates intersection points 130 from the portions, and some examples further involve outputting a mesh generated based on the intersection points 130. In an example, the virtual shell is a convex hull 214 formed based on intersection points 130 from the portions.

### Example System and Device

FIG. 10 illustrates an example system generally at 1000 that includes an example computing device 1002 that is representative of one or more computing systems and/or devices that implement the various techniques described herein. This is illustrated through inclusion of the sphere carving module 116. The computing device 1002 is configurable, for example, as a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing system 1004. The instructions and/or functions are executable/operable by one or more articles of manufacture (for example, one or more computing devices and/or processing systems 1004) to implement techniques, modules, and examples described herein.

The techniques described herein are supported by various configurations of the computing device 1002 and are not limited to the specific examples of the techniques described herein. This functionality is also implementable through use of a distributed system, such as over a “cloud” 1114 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized when computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

What is claimed is:

1. A method comprising:
receiving, by a processing device, data indicating distances from points in space to a surface of a three-dimensional object;
identifying, by the processing device, a virtual representation that encloses the three-dimensional object;
generating, by the processing device, a virtual shell based on a geometry of the three-dimensional object by iteratively removing portions between a surface of the virtual representation and the surface of the three-dimensional object; and
outputting, by the processing device, data related to the virtual shell.

2. The method of claim 1, wherein the data involves a signed distance field function.

3. The method of claim 1, wherein the virtual representation and the portions between the surface of the virtual representation and the surface of the three-dimensional object have a spherical geometry.

4. The method of claim 1, wherein the data related to the virtual shell indicates intersection points from the portions, and further comprising outputting a mesh generated based on the intersection points.

5. The method of claim 1, wherein the virtual shell is a bounding volume.

6. The method of claim 1, wherein the data related to the virtual shell indicates multiple component three-dimensional objects that form the three-dimensional object.

7. The method of claim 1, further comprising selecting a size of the virtual representation that avoids intersecting the surface of the three-dimensional object.

8. The method of claim 1, wherein the iteratively removing the portions between the surface of the virtual representation and the surface of the three-dimensional object involves determining distances of surface points of the portions to the surface of the three-dimensional object.

9. The method of claim 1, wherein the data related to the virtual shell indicates a convex hull formed based on intersection points from the portions.

10. A system comprising:
a memory component; and
a processing device coupled to the memory component, the processing device to perform operations comprising:
receiving data indicating distances from points in space to a surface of a three-dimensional object;
identifying a virtual spherical representation that encloses the three-dimensional object;
generating a virtual shell having a geometry of the three-dimensional object based on intersection points of portions iteratively removed between a surface of the virtual spherical representation and the surface of the three-dimensional object; and
rendering the virtual shell in a user interface.

11. The system of claim 10, wherein the distances are part of a signed distance field function.

12. The system of claim 10, further configured to perform operations comprising outputting a mesh generated based on the intersection points.

13. The system of claim 10, wherein the virtual shell is a bounding volume.

14. The system of claim 10, further configured to perform operations comprising selecting a size of the virtual spherical representation that avoids intersecting the surface of the three-dimensional object.

15. The system of claim 10, wherein the iteratively removing the portions between the surface of the virtual spherical representation and the surface of the three-dimensional object involves determining distances of surface points of the portions to the surface of the three-dimensional object.

16. The system of claim 10, wherein the virtual shell is a convex hull.

17. A method comprising:
receiving, by a processing device, data involving a function related to locations of surface points of a three-dimensional object in a virtual environment;
generating, by the processing device, a virtual shell having a spherical geometry that encloses the three-dimensional object in the virtual environment based on the locations of the surface points;
determining, by the processing device, an updated geometry for the virtual shell by carving portions between a surface of the virtual shell and a surface of the three-dimensional object; and
outputting, by the processing device, data related to the virtual shell based on the updated geometry.

18. The method of claim 17, wherein the function related to the locations of the surface points of the three-dimensional object is a signed distance field function.

19. The method of claim 17, wherein the data related to the virtual shell indicates intersection points from the portions, and further comprising outputting a mesh generated based on the intersection points.

20. The method of claim 17, wherein the virtual shell is a bounding volume.
